(19) United States
(12) Patent Application Publication
(10) Pub. No.: US 2026/0037920 A1
(43) Pub. Date: Feb. 5, 2026

(54) PRODUCT BLENDING OPTIMIZATION

(71) Applicant: Infor (US), LLC, New York City, NY (US)

(72) Inventors: Anastasios Viglas, Miami, FL (US); Inderjeet Singh, Columbus, IN (US); Padmakiran Penchala, Alpharetta, GA (US)

(21) Appl. No.: 19/281,773

(22) Filed: Jul. 28, 2025

Related U.S. Application Data
(60) Provisional application No. 63/678,156, filed on Aug. 1, 2024.

(51) Int. Cl. G06Q 10/087; G06Q 10/04

(52) U.S. Cl. CPC G06Q 10/0872; G06Q 10/04; G06Q 10/0877

(57) ABSTRACT

Disclosed are various embodiments for product blending optimization. In one embodiment, inventory data is received that represents a plurality of product layers stored in a plurality of storage units. The inventory data indicates a product quantity for each of the product layers and a set of characteristics for each of the product layers. Order data is received that represents a plurality of orders for a blended product. Each of the orders specifies a respective set of target characteristics for the blended product and a respective quantity. Based on the inventory data and the order data, an optimal sequence of the plurality of orders for fulfillment is automatically generated, along with an optimal sequence for dispensing product from the storage units for the blended product of each respective order.

### BACKGROUND

Various products may be manufactured through blending multiple components. In the context of petroleum products, for example, retail gasoline may comprise a blend of gasoline and ethanol, and retail diesel may comprise a blend of diesel and biodiesel. In the context of malt production, multiple lots of a grain, such as barley, may be blended together, where the lots may have different characteristics. Accordingly, the characteristics of the blended malt product may depend on the respective characteristics of the blended lots.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing of an example grain storage system according to various embodiments of the present disclosure.

FIG. 1B is a drawing of a silo from FIG. 1A that illustrates interfaces between different layers according various embodiments of the present disclosure.

FIG. 2 is a schematic block diagram of a networked environment according to various embodiments of the present disclosure.

FIG. 3 is a flowchart illustrating one example of functionality implemented as portions of a blending optimization service executed in a computing environment in the networked environment of FIG. 2 according to various embodiments of the present disclosure.

FIG. 4 is a flowchart illustrating one example of functionality implemented as portions of an intake optimization service executed in a computing environment in the networked environment of FIG. 2 according to various embodiments of the present disclosure.

FIG. 5 is a schematic block diagram that provides one example illustration of a computing environment employed in the networked environment of FIG. 2 according to various embodiments of the present disclosure.

### DETAILED DESCRIPTION

The present disclosure generally relates to systems and methods for automatically optimizing and orchestrating a blend of multiple existing lots of products to achieve a final mixed product that satisfies given specifications. The lots may correspond to material of different quality and composition. Constraints pertaining to the blend of lots may be that the lots are situated in parallel silos, pipelines, or other storage units. Further, some storage units may be loaded from one end and unloaded from the other end, such that the product is offloaded from the storage unit in a first-in-first-out (FIFO) manner. Other storage units may also allow loading from the same end they are loaded in a last-in-first-out (LIFO) manner. Manual approaches to determining how to blend the lots of products may be suboptimal because of the complexity of arranging fulfillment of orders.

One specific scenario involves the grain blending problem. A grain supplier may operate warehouses where potentially multiple types of grains are stored in multiple silos. Grain arrives in batches from producers and may be added to the silos after processing. Each batch that arrives at the warehouse from a producer has its own characteristics. These characteristics may be measured by several quality parameters. As batches of grain material arrive from producers, the batches are added to a particular silo at the top of the silo. However, the silo may already contain grain material from a previous delivery. This receiving process results in having multiple layers of grain material stored in each silo, where each of the layers may have potentially distinct characteristics. Non-limiting examples of grain characteristics may include various levels of moisture, extract fine, extract coarse, color, protein, Kolbach index, free amino nitrogen, beta-glucan, and so on.

The grain supplier receives customer orders, and each order may specify a list of requirements or preferences in terms of the quality parameters of the grain. The grain supplier may need to blend multiple layers of grain from multiple silos to satisfy the customer orders. Each blend performed by the grain supplier may satisfy one or multiple customer orders. Satisfying multiple customer orders in a single blend is of particular interest to grain suppliers as it reduces effort and cost.

The most demanding step in the blending process is deciding which layers to blend in order to achieve the preferred requirements. The requirements may involve dozens of quality parameters, multiple silos, and multiple layers in each silo. In addition, there may be multiple constraints to the blending process. For example, the grain may be accessible only from the bottom of the silo, and the grain must be used up in the FIFO order in which it was added to the silo.

Conventional approaches have used a long manual process of trial and error. This manual trial-and-error process is time consuming, requires significant experience from staff performing the process, and will often result in a sub-optimal blend, or a sub-optimal use of available resources. Also, due to the complexity of finding a suitable blend, the user is more likely to be conservative, and always select a single customer order to work with, and as few silos as possible. These limitations make it more likely for the outcome to be sub-optimal, resulting in less effective use of the available grain.

Various embodiments of the present disclosure introduce an automated product blending process using an optimization model based on mixed integer linear programming, which may be configured specifically for the constraints of product blending. The system architecture may combine an application platform, a database, an order processing system, and the optimization algorithm for the blending process. A flexible optimization objective can incorporate multiple goals and can prioritize these goals.

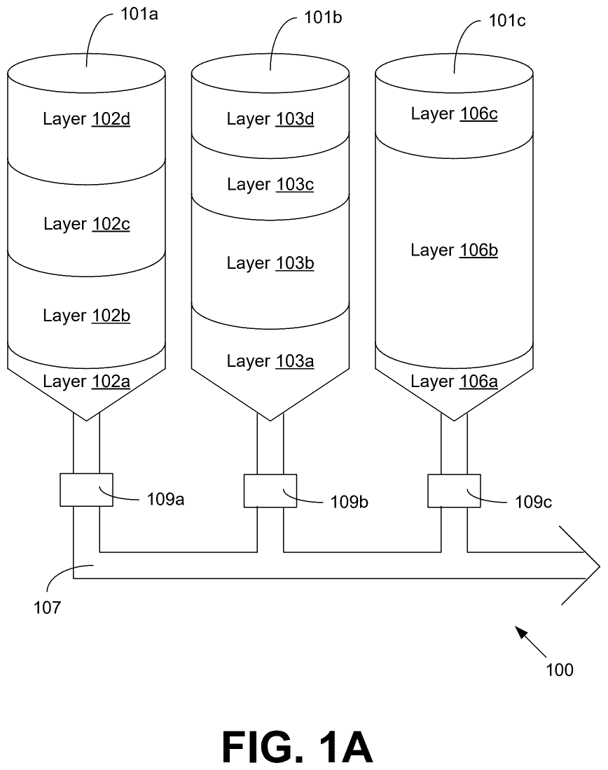

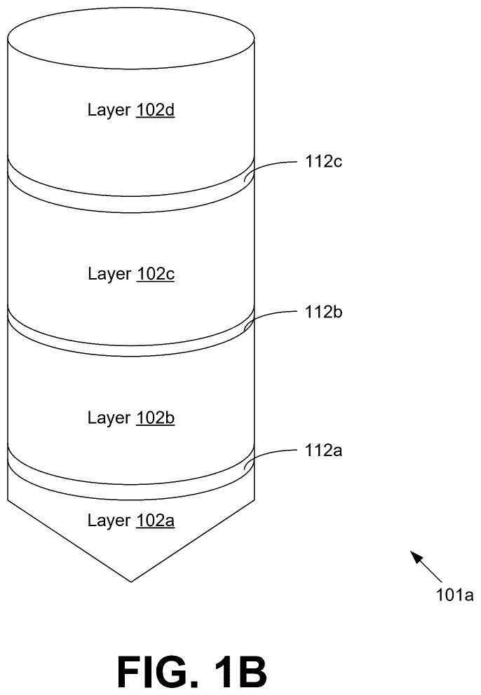

With reference to FIG. 1A, shown is a drawing of one example of a grain storage system 100 according to one or more embodiments. In this non-limiting example, there are three storage silos 101a, 101b, and 101c, though different numbers of silos 101 may be used in other examples of grain storage systems 100. The silos 101 are always loaded from the top and emptied from the bottom.

Each of the silos has a number of different layers of grain. For example, silo 101a has four layers: layer 102a, 102b, 102c, 102d. Layer 102a was loaded first into the silo 101a and will be dispensed next, while layer 102d was loaded last into the silo 101a and will be dispensed last. Silo 101b also has four layers: layer 103a, 103b, 103c, 103d. Layer 103a was loaded first into the silo 101b and will be dispensed next, while layer 103d was loaded last into the silo 101b and will be dispensed last. Silo 101c has three layers: layer 106a, 106b, and 106c. Layer 106a was loaded first into the silo 101c and will be dispensed next, while layer 106c was loaded last into the silo 101c and will be dispensed last. The number of layers shown in the respective silos 101 is illustrative only and there may be more layers or fewer layers. Also, the volume or quantity of the respective layers may differ.

Connected to the bottom of the silos 101 is an outflow system 107, which may include a network of pipes, conveyors, and mixers to produce a blended product. The blended product may be loaded into an outflow silo for future use, or may be loaded onto a vehicle. In one scenario, the blended grain may be transported for use in malt production, where the blended grain may be steeped, germinated, kilned, roasted, and/or deculmed to produce a malt. The resulting malts may also be stored in a different set of silos 101 and subsequently blended according to a similar system. The precise blending of the products may be controlled by a respective valve 109a, 109b, and 109c, which may be a manually operated value or an electrically actuated valve in various embodiments.

For example, it may be desired to blend grain from layer 102a with layer 106a, in which case a quantity of layer 102a may be dispensed through the control of the valve 109a, and a quantity of layer 106a may be dispensed through control of the valve 109c. The quantities need not be equal, as a blend may call for different quantities of the different lots of grain according to their respectively different characteristics. In another example, it may be desired to blend grain from layer 102a with layer 103b. In such a case, layer 103b must be dispensed first to fulfill another order before layer 103b can be dispensed.

Turning now to FIG. 1B, shown is a drawing of the silo 101a (FIG. 1A) that illustrates interfaces 112 between the different layers 102. An interface 112 corresponds to a blend between two layers 102 that naturally results when loading one layer 102 on top of another layer 102. For example, the interface 112a is a blend between the layer 102a and 102b, the interface 112b is a blend between the layer 102b and the layer 102c, and the interface 112c is a blend between the layer 102c and the layer 102d. The quantities included in the interface 112 may be relatively constant or may vary based upon loading. The grain or other product in the interface 112 may have a set of characteristics that are considered mixed from the respective sets of characteristics of the layers 102. In some cases, the characteristics may be considered to be the worse characteristics of the two of the layers 102b or the average characteristics of the two of the layers 102b when used as an input to determine quantities for blending to meet target characteristics of a customer order.

The principles of interfaces 112 may also apply to batches of fluid products transported serially through a pipeline, such as petroleum products, where the interface 112 is a mixture of fluids that may be suitable for specific uses that may differ from the suitable uses of the respective layers 102 individually. For example, gasoline may be sent first, followed by jet fuel, and then followed by diesel, where the interfaces 112 respectively correspond to a gasoline-jet fuel mixture and a jet fuel-diesel mixture.

As one skilled in the art will appreciate in light of this disclosure, certain embodiments may be capable of achieving certain advantages, including some or all of the following: (1) improved functioning for computer systems to allow reordering of customer orders to minimize the number of orders that cannot be fulfilled; (2) improved functioning for material storage systems to facilitate automated blending of material to customer specifications; (3) improved functioning for material storage systems to minimize deviations from target characteristics when it is impossible to meet customer requirements; (4) improved functioning for user interfaces that control the automated blending of material; and so forth. In the following discussion, a general description of the system and its components is provided, followed by a discussion of the operation of the same.

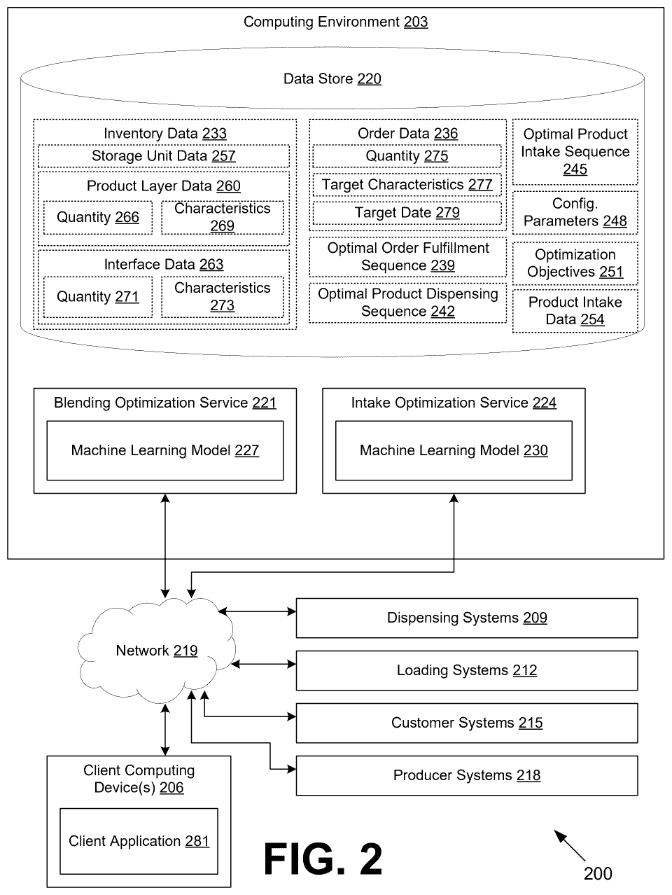

With reference to FIG. 2, shown is a networked environment 200 according to various embodiments. The networked environment 200 includes a computing environment 203, one or more client computing devices 206, one or more dispensing systems 209, one or more loading systems 212, one or more customer systems 215, and one or more producer systems 218, which are in data communication via a network 219. The network 219 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource, and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 220 that is accessible to the computing environment 203. The data store 220 may be representative of a plurality of data stores 220 as can be appreciated. The data stored in the data store 220, for example, is associated with the operation of the various applications and/or functional entities described below.

The components executed on the computing environment 203, for example, include a blending optimization service 221, an intake optimization service 224, and other applications, services, processes, systems, engines, or functionality not discussed in detail herein. The blending optimization service 221 is executed to determine an optimal sequence for fulfillment of customer orders for a blended product via a plurality of product lots that are stored in a plurality of storage units. Further, the blending optimization service 221 may determine an optimal sequence for dispensing product from the various storage units. Optimality may be determined based at least in part on minimizing the number of orders that cannot be fulfilled due to the state of the storage units and ensuring that the characteristics of the blended product fall within an acceptable target range pertaining to an order.

In some embodiments, a machine learning model 227 may be trained based upon past orders and past fulfillment of those orders in order to generate an ideal sequence of the current orders or an ideal sequence of dispensing product from the storage units. In other embodiments, a mixed integer linear algorithm may be employed in order to generate an ideal sequence of the current orders or an ideal sequence of dispensing product from the storage units.

The intake optimization service 224 is executed to determine an optimal sequence of product intake into a set of storage units. The optimal sequence may indicate a specific set of one or more storage units and the quantity of product from a lot to be loaded into each of the storage units. In a first example, the intake optimization service 224 may determine that the entire quantity of a product lot be loaded into one particular storage unit. In another example, the intake optimization service 224 may determine that a first quantity of a product lot should be loaded into a first storage unit, while a second quantity of the same product lot should be loaded into a second storage unit. To the extent practicable, the intake optimization service 224 may also arrange or rearrange deliveries of product lots from product producers to organize in what order the product layers are loaded into the storage units. In some embodiments, a machine learning model 230 may be trained based upon past orders in order to predict future orders, which can then be used to organize intake of the products.

The machine learning models 227 and 230 may be selected from various types of machine learning models in various embodiments. Supervised learning models, such as regression and classification, enable the prediction of optimal parameters based on historical data. Meanwhile, unsupervised learning models like clustering and association rule learning reveal underlying patterns within configurations, aiding in the identification of optimal clusters or correlated parameters. Reinforcement learning, on the other hand, empowers agents to iteratively adjust parameters and observe their effects, gradually honing-in on the optimal configuration through trial and error. Deep learning models, including deep neural networks, convolutional neural networks, and recurrent neural networks, leverage their ability to discern complex patterns within vast datasets, proving particularly effective when dealing with intricate data. Additionally, evolutionary algorithms, inspired by natural selection, iteratively improve configurations by selecting the fittest candidates and applying genetic operations to generate new configurations. Bayesian optimization, employing probabilistic models, efficiently explores configuration spaces to identify the most promising configurations for evaluation.

The data stored in the data store 220 includes, for example, inventory data 233, order data 236, an optimal order fulfillment sequence 239, an optimal product dispensing sequence 242, an optimal product intake sequence 245, one or more configuration parameters 248, one or more optimization objectives 251, product intake data 254, and potentially other data.

The inventory data 233 may include data relating to the state of a product storage and dispensing system in terms of what product is stored, in what quantity, and in what location. The inventory data 233 may include storage unit data 257, product layer data 260, interface data 263, and/or other data. The storage unit data 257 may describe various storage units, such as silos, pipelines, and/or other units, in terms of total capacity, used capacity, suitable products, which storage units can be blended together due to piping or proximity, and the product layers stored in the respective storage units.

The product layer data 260 may include data describing respective product layers in the storage units. The product layer data 260 may include a quantity 266 and a set of characteristics 269. The quantity 266 may be expressed in terms of weight, volume, or time to be dispensed through a dispenser of the storage unit. The set of characteristics 269 may include parameters relating to the quality of the product layer. Different product lots may have differing quality levels and may be suitable for different applications. For example, one customer order may specify a high-quality grain blend for a higher cost, while another customer order may specify a low-quality grain blend for a lower cost. In the case of barley or malt used in the manufacturing of beer, the customer order may specify a set of characteristics 269 for the barley or malt that translate to a particular flavor or quality of the beer. In the non-limiting example of grain, the characteristics 269 may include moisture, extract fine, extract coarse, color, protein, Kolbach index, free amino nitrogen, beta-glucan, and other parameters. In some cases, the set of characteristics 269 may be determined based at least in part on a laboratory review of a sample of the product layer.

The interface data 263 relates to information about an interface between two product layers stored next to each other in a storage unit. The interface can have a respective quantity 271 and a respective set of characteristics 273, which would be a blend of the characteristics of the two product layers making up the interface.

The order data 236 includes data describing a set of customer orders for products. The order data 236 may include for each order a respective quantity 275, a respective set of target characteristics 277, a target data 279, and/or other data. The quantity 275 is the amount ordered, expressed in terms of weight, volume, or time to be dispensed through a dispenser of the storage unit. The target characteristics 277 may correspond to a set of quality characteristics that the ordered product should have. The target characteristics 277 may be expressed by minimum values for a parameter, maximum values for a parameter, average values for a parameter, etc. In some cases, the target characteristics 277 may be expressed by a reference value, which may be fulfilled by the blending optimization service 221 with respect to ranges or tolerances configured for the blending optimization service 221.

The target date 279 may be a date and/or time by which the order must be dispensed, shipped, and/or delivered. In some cases, the target date 279 may be a date the order was placed plus a lead time. The target date 279 may be a parameter used by the blending optimization service 221 and/or the intake optimization service 224 to optimize a fulfillment sequence, dispensing sequence, or intake sequence.

The optimal order fulfillment sequence 239 is a sequence by which orders for product are fulfilled. Since not every product layer is immediately accessible, and different product layers may have different characteristics 269, some orders may not be fulfilled with blends from the product layers that are currently available to be dispensed from the storage units. Accordingly, the optimal order fulfillment sequence 239 generated by the blending optimization service 221 may rearrange the orders in a sequence for fulfillment in order to minimize orders that cannot be fulfilled.

The optimal product dispensing sequence 242 is a sequence by which product is to be dispensed from respective storage units and blended. The optimal product dispensing sequence 242 may be generated from the optimal order fulfillment sequence 239 on the basis of which products are to be dispensed and blended together and in what volumes. For example, the optimal product dispensing sequence 242 may specify that 100 lbs. of product should be dispensed from silo A, and 50 lbs. of product should be dispensed from silo B, such that the products are mixed together. The mixing of the characteristics 269 of the product layers in the proportion specified may result in blended characteristics 269 that meet the target characteristics 277.

The optimal product intake sequence 245 is a sequence by which products are to be loaded into respective storage units. The optimal product intake sequence 245 may specify specific storage units for intake that are optimal in view of the current state of the storage units and predicted future orders. In some cases, the optimal product intake sequence 245 may schedule or reorder deliveries from producers in order to provide this optimal loading.

The configuration parameters 248 may be provided by the system operator and may be specific to the blending process. For example, the configuration parameters 248 may include a maximum number of storage units that can be used in a single blend (e.g., four silos out of ten silos total), a minimum amount that may be dispensed from each storage unit, the ability to use product from one end or two ends of the storage unit, and so forth.

The optimization objectives 251 are goals used in the blend optimization process. The optimization objectives 251 may include a cost of each lot, one or more priorities associated with each target characteristic 277, and so on. The product intake data 254 may describe products that are en route to the storage units or are to be ordered. In some cases, the product intake data 254 may be generated by the intake optimization service 224 based on predicted future orders. In other cases, the product intake data 254 may be manually created.

The client computing device 206 is representative of a plurality of client devices that may be coupled to the network 219. The client computing device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client computing device 206 may include a display comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client computing device 206 may be configured to execute various applications such as a client application 281 and/or other applications. The client application 281 may be executed in a client computing device 206, for example, to access network content served up by the computing environment 203 and/or other servers, thereby rendering a user interface on the display. The user interface may include a display of an optimal order fulfillment sequence 239, optimal product dispensing sequence 242, or optimal product intake sequence 245. To this end, the client application 281 may comprise, for example, a browser, a dedicated application, etc., and the user interface may comprise a network page, an application screen, etc. The client computing device 206 may be configured to execute applications beyond the client application 281 such as, for example, email applications, social networking applications, word processors, spreadsheets, and/or other applications.

The dispensing systems 209 may correspond to mechanical or electro-mechanical, or computer operated, systems that dispense product from one or more storage units and blend the resulting product. The dispensing systems 209 may include for example various valves 109, blenders, conveyors, loaders, pipes, and so forth. In some cases, product may be dispensed directly into a vehicle, rail car, or pipeline for transport, product may be dispensed into an outloading storage unit, or product may be dispensed into a next step in a manufacturing process, such as the creation of malt from grain.

The loading systems 212 may correspond to mechanical or electro-mechanical, or computer operated, systems used to load product into the storage units. The loading systems 212 may include valves, conveyors, pipes, etc., that can transport product from a receiving hopper or facility to a particular storage unit.

The customer systems 215 are client computing devices or other computer systems operated by customers that generate and transmit orders for product. The producer systems 218 are computer systems operated by producers that can receive orders or instructions with respect to delivery of the products to the storage units.

Next, a general description of the operation of the various components of the networked environment 200 is provided. The optimization process of the blending optimization service 221 will attempt to satisfy all business requirements for every selected customer order. In many cases this is not feasible. In such cases, the optimization process will produce a result that minimizes the deviation from the provided constraints and is the best achievable given the available inventory. The deviation from customer constraints is related to the customer target characteristics 277. If there does not exist a way to produce a blend that satisfies all quality requirements, then the blending optimization service 221 may suggest a blend that minimizes the aggregate deviation from the requirements. When calculating the aggregate deviation, the blending optimization service 221 may take into account the priorities set by the warehouse operator for each of the target characteristics 277.

A mixed integer linear program may be used for solving the blending. The core of the optimization model is a generalization of the classic “recipe optimization” problem. However several aspects of product blending do not allow the use of simple extensions of the recipe optimization model: (1) the requirement to use the product layers in the sequence they were added to the storage units, (2) the ability to consider multiple customer order requirements at the same time and satisfy the maximum number of them in one model, (3) the constraint on the number of storage units to use in each blend, and (4) other requirements which are site-specific, such as the minimum amount of material to use from each selected storage unit.

Begin with J storage units, each one containing lots of a product. Assume the maximum number of lots or layers in any storage unit is K. The k-th lot in the j-th storage unit is denoted by B(j, k). Each lot B(i, j) is associated with R quality parameters, denoted by Q(j, k, r) for r∈1, . . . , R. Assume that lot k from storage unit j is associated with cost C(j, k). This is the cost to the warehouse, per unit of weight or volume.

If quantity w(j, k) from lot k of storage unit j is blended, the r-th quality parameter of the resulting blend may be calculated using a weighted average:

$$\frac{{\sum }_{j , k} {w}_{j , k} \cdot Q ( j , k , r )}{{\sum }_{j , k} {w}_{j , k}}$$

Given I customer order lines, each order line is associated with a quantity W(i), a minimum target quality parameter L(i, r) and maximum target quality parameter U(i, r). Without loss of generality, assume that the orders have both lower and upper bounds on all quality parameters. Assume that in some embodiments the storage units can be accessed only from one output end. The goal is to find a sequence of orders, one for each customer order line. This goal will be updated later to pool multiple order lines in one manufacturing order.

A manufacturing order is a sequence of weights, w(i, j, k), each denoting an amount of product to be used from lot k, in storage unit j, for the manufacturing order i. Two objectives are considered: (1) minimize deviation from customer order quality specifications and (2) minimize cost. The two objectives may be balanced based at least in part on an input parameter. The objective may be modified to minimize the number of manufacturing orders.

A single-full-blend optimization model is a mixed integer linear program that solves the blending problem: given a set of customer orders, find the optimal blend that minimizes deviation from the given goals. This model attempts to satisfy given all orders, even if their requirements are dissimilar and the resulting single blend will be potentially a poor solution. However, if the available product is not enough to satisfy all orders, then the described model will choose an optimal subset to satisfy. Therefore, this model simultaneously selects an optimal subset of the selected customer orders and decides on the optimal contents to use for the blend. Optimal choices are defined based at least in part on a flexible list of optimization objectives.

Sets and indices are described as follows: (1) a set of J storage units: Sₛᵢₗₒ={j:1≤j≤J}; (2) a set of K possible layer ranks, S_{layer}=k: 1≤k≤K, where the bottom-most layer in the storage unit is assigned k=0; (3) a set of R quality parameters S_{q}=r:1≤r≤R; and (4) a set of I customer orders with index S_{CO}={i:1≤i≤I}.

Parameters are described as follows: (1) X is the maximum number of storage units to use for a single order; (2) W(j, k) is the amount available in the k-th layer of the j-th storage unit; (3) Q(j, k, r) is the r-th quality indicator (test result) of the k-th batch in storage unit j; (4) C(j, k) is the cost per unit for the k-th batch in storage unit j; (5) T(i) is the quantity required by the i-th order; (6) L(i, r) is the minimum value required for the r-th quality indicator of the i-th order; and (7) U(i, r) is the maximum value required for the r-th quality indicator of the i-th order.

Variables are described as follows: (1) w(i, j, k) is the quantity of the k-th batch in storage unit j used by the i-th order; (2) b(i, r) where the r-th quality parameter of the i-th order is below the lower bound by this quantity (zero if there is no violation); (3) a(i, r): The r-th quality parameter of the i-th order is above the upper bound by this quantity (zero if there is no violation); (4) y(j, k) is an indicator variable that indicates that all layers are used up to and including layer k−1 in storage unit j, and lot k can be used; (5) x(j)∈0, 1 is an indicator variable, where x(j)=1 if and only if storage unit j is being used; and (6) r(i) is an indicator variable, where r(i)=1 if and only if the i-th order is fulfilled.

Constraints are given as follows:

The total weight used from each lot is less than the available quantity:

$$∀ j , k : {\sum }_{i} w ( i , j , k ) \leq W ( j , k )$$

The total weight for each order matches the requirement if the customer order is fulfilled:

$$∀ j : {\sum }_{j , k} w ( i , j , k ) = T ( i ) \cdot r ( i )$$

The deviation from quality lower bounds (for orders that are fulfilled):

$$∀ i , r : b ( i , r ) \geq L ( i , r ) \cdot {\sum }_{i , j , k} w ( i , j , k ) - {\sum }_{i , j , k} ( Q ( j , k , r ) \cdot w ( i , j , k ) )$$

$$b ( i , r ) \geq 0$$

The deviation from upper quality bounds:

$$∀ i , r : a ( i , r ) \geq {\sum }_{i , j , k} ( Q ( j , k , r ) \cdot w ( i , j , k ) ) - U ( i , r ) \cdot {\sum }_{i , j , k} w ( i , j , k )$$

$$a ( i , r ) \geq 0$$

A product layer is used only if all layers below it has already been used:

$$∀ j , k : {\sum }_{i , {k}^{′} \leq k - 1} w ( i , j , {k}^{′} ) \geq {\sum }_{{k}^{′} \leq k - 1} W ( j , {k}^{′} ) - M \cdot ( 1 - y ( j , k ) )$$

$$∀ i , j , k : w ( i , j , k ) \leq M \cdot y ( j , k )$$

$$∀ j , k : y ( j , k ) ∈ 0 , 1$$

Use at most X storage units for each order:

$$∀ j : {\sum }_{j , k} w ( i , j , k ) \leq M \cdot x ( j )$$

$${\sum }_{j} x ( j ) \leq X$$

The multiple parts of this objective constitute a minimization problem in terms of the following:

(1) Minimize the number of orders that are not fulfilled (with a high priority/weight):

$$I - {\sum }_{i} r ( i )$$

(2) Minimize total cost:

$${\sum }_{i , j , k} C ( j , k ) \cdot w ( i , j , k )$$

(3) Minimize the deviation from the lower bounds for the quality parameter:

$${\sum }_{i , r} b ( i , r )$$

(4) Minimize the deviation from the upper bounds for the quality parameter:

$${\sum }_{i , r} a ( i , r )$$

The single-blend process solves the most complex part of deciding the blend specification for a selected set of customer orders. There is an additional aspect of the blending process which relates to scheduling the sequence in which customer orders are considered. Even though the scheduling is driven by due dates, there are cases to consider customer orders in a specific order to optimize the use of the available inventory. Combining the blend specification decision and the scheduling of the sequence in which customer orders are fulfilled, yields a complex problem which may use a more complex mathematical model as described in the following:

Sets and indices are described as follows: (1) a set of J storage units: Sₛᵢₗₒ={j:1≤j≤J}; (2) a set of K possible layer ranks, S_{layer}=k: 1≤k≤K, where the bottom-most layer in the storage unit is assigned k=0; (3) a set of R quality parameters S_{q}=r:1≤r≤R; and (4) a set of I customer orders with index S_{CO}={i:1≤i≤I}.

Parameters are described as follows: (1) X is the maximum number of storage units to use for a single order; (2) M is the maximum number of manufacturing orders to generate; (3) W(j, k) is the amount available in the k-th layer of the j-th storage unit; (4) Q(j, k, r) is the r-th quality indicator (test result) of the k-th batch in storage unit j; (5) C(j, k) is the cost per unit for the k-th batch in storage unit j; (6) T(i) is the quantity required by the i-th order; (7) L(i, r) is the minimum value required for the r-th quality indicator of the i-th order; and (8) U(i, r) is the maximum value required for the r-th quality indicator of the i-th order.

Variables are described as follows: (1) w(m, i, j, k) is the quantity of the k-th batch in storage unit j used by the i-th order, in the m-th manufacturing order; (2) b(i, r) where the r-th quality parameter of the i-th order is below the lower bound by this quantity (zero if there is no violation); (3) a(i, r): The r-th quality parameter of the i-th order is above the upper bound by this quantity (zero if there is no violation); (4) y(m, j, k) is an indicator variable that indicates that all layers are used up to and including layer k−1 in storage unit j, and lot k can be used, in the m-th manufacturing order; (5) x(m, j)∈0, 1 is an indicator variable, where x(j)=1 if and only if storage unit j is being used, in the m-th manufacturing order; (6) p(m,i)∈0, 1 is an indicator variable that is equal to 1 if and only if the customer order i is associated with manufacturing order m; (7) z(m)∈0, 1 is an indicator variable that is equal to 1 if and only if there exists a customer order associated with manufacturing order m; and (8) r(i) is an indicator variable, where r(i)=1 if and only if the i-th order is fulfilled.

Constraints are given as follows:

The total weight used from each lot is less than the available quantity:

$$∀ j , k : {\sum }_{m , i} w ( m , i , j , k ) \leq W ( j , k )$$

The total weight for each order matches the requirement if the customer order is fulfilled:

$$∀ j : {\sum }_{m , j , k} w ( m , i , j , k ) = T ( i ) \cdot r ( i )$$

The deviation from quality lower bounds (for orders that are fulfilled):

$$∀ i , r : b ( i , r ) \geq {\sum }_{m} ( L ( i , r ) \cdot {\sum }_{i , j , k} w ( m , i , j , k ) - {\sum }_{i , j , k} ( Q ( j , k , r ) \cdot w ( m , i , j , k ) ) ) = L ( i , r ) \cdot {\sum }_{m , i , j , k} w ( m , i , j , k ) - {\sum }_{m , i , j , k} ( Q ( j , k , r ) \cdot w ( m , i , j , k ) )$$

$$b ( i , r ) \geq 0$$

The deviation from upper quality bounds:

$$∀ i , r : a ( i , r ) \geq {\sum }_{m} ( {\sum }_{i , j , k} ( Q ( j , k , r ) \cdot w ( m , i , j , k ) ) - U ( i , r ) \cdot {\sum }_{i , j , k} w ( m , i , j , k ) ) = {\sum }_{m , i , j , k} ( Q ( j , k , r ) \cdot w ( m , i , j , k ) ) - U ( i , r ) \cdot {\sum }_{m , i , j , k} w ( m , i , j , k )$$

$$a ( i , r ) \geq 0$$

A product layer is used only if all layers below it has already been used:

$$∀ m , j , k : {\sum }_{{m}^{′} \leq m , i , {k}^{′} \leq k - 1} w ( {m}^{′} , i , j , {k}^{′} ) \geq {\sum }_{{k}^{′} \leq k - 1} W ( j , {k}^{′} ) - M \cdot ( 1 - y ( m , j , k ) )$$

$$∀ m , i , j , k : w ( m , i , j , k ) \leq M \cdot y ( m , j , k )$$

$$∀ m , j , k : y ( m , j , k ) ∈ 0 , 1$$

Use at most X storage units for each order:

$$∀ m , j : {\sum }_{j , k} w ( m , i , j , k ) \leq M \cdot x ( m , j )$$

$$∀ m : {\sum }_{j} x ( m , j ) \leq X$$

Next, mapping customer orders to manufacturing orders is described:

Assigning product to a customer order index i only if the customer order is assigned to the manufacturing order m:

$$∀ m , i : {\sum }_{j , k} w ( m , i , j , k ) \leq M \cdot p ( m , i )$$

$$∀ i : {\sum }_{m} p ( m , i ) \leq r ( i )$$

A manufacturing order m can satisfy up to I customer orders, only if it is active:

$$∀ m : {\sum }_{i} p ( m , i ) \leq I \cdot z ( m )$$

If a manufacturing order m is active, then it fulfills at least one customer order:

$$∀ m : {\sum }_{i} p ( m , i ) \geq z ( m )$$

The total number of customer orders mapped is equal to the total active customer orders:

$${\sum }_{m , i} p ( m , i ) = {\sum }_{i} z ( i )$$

The active manufacturing orders start from m=0 and use indices continuously:

$$∀ m : z ( m ) \leq z ( m + 1 )$$

The multiple parts of this objective constitute a minimization problem in terms of the following:

(1) minimize the number of orders that are not fulfilled (with a high priority/weight):

$$I - {\sum }_{i} r ( i )$$

(2) Minimize the number of manufacturing orders:

$${\sum }_{m} z ( m )$$

(3) Minimize total cost:

$${\sum }_{m , i , j , k} C ( j , k ) \times w ( m , i , j , k )$$

(4) Minimize the deviation from the lower bounds for the quality parameter:

$${\sum }_{i , r} b ( i , r )$$

(5) Minimize the deviation from the upper bounds for the quality parameter:

$${\sum }_{i , r} a ( i , r )$$

The mathematical models presented so far assume that the material is available in a certain sequence (for example, first-in-first-out, or bottom layer first). In certain cases, storage units may allow the use of the existing material lots from multiple endpoints. For example, in grain blending, layers of grain are stored in silos, and those layers can be accessed from the bottom of the silo (first-in-first-out). There are, however, other silos that also allow the use of grain from the top of the silo (last-in-first-out). The mathematical models can be extended to allow the use of raw material either in a bottom-up manner (FIFO, oldest first), or top-down (LIFO, or most recent first), or both modes. The following is a mathematical model that allows both bottom-up and top-down use, based on the configuration of the storage units.

Sets and indices are described as follows: (1) a set of J storage units: Sₛᵢₗₒ={j:1≤j≤J}; (2) a set of K possible layer ranks, S_{layer}=k: 1≤k≤K, where the bottom-most layer in the storage unit is assigned k=0; (3) a set of R quality parameters S_{q}=r:1≤r≤R; (4) a set S^{(t)} of storage units, a subset of Sₛᵢₗₒ, which can be accessed from the top-most layer as well as the bottom-most layer; and (5) a set of I customer orders with index S_{CO}={i:1≤i≤I}.

Variables are described as follows: (1) w^{(b)}(m, i, j, k) is the quantity of the k-th batch in storage unit j used by the i-th order, in the m-th manufacturing order, to be used for quantities that use up material bottom up; (2) w^{(t)}(m, i, j, k) is the quantity of the k-th batch in storage unit j used by the i-th order, in the m-th manufacturing order, to be used for quantities that use up material top down; (3) w(m, i, j, k) is the quantity of the k-th batch in storage unit j used by the i-th order, in the m-th manufacturing order; (4) b(i, r) where the r-th quality parameter of the i-th order is below the lower bound by this quantity (zero if there is no violation); (5) a(i, r): The r-th quality parameter of the i-th order is above the upper bound by this quantity (zero if there is no violation); (6) y^{(b)}(m, j, k) is an indicator variable that indicates that all layers are used up to and including layer k−1 in storage unit j, and lot k can be used, in the m-th manufacturing order; (7) y^{(t)}(m, j, k) is an indicator variable that indicates that all layers from layer k+1 and up in storage unit j are used by manufacturing orders 1, . . . , m, and lot k can be used, in the m-th manufacturing order; (8) x(m, j)∈0, 1 is an indicator variable, where x(j)=1 if and only if storage unit j is being used, in the m-th manufacturing order; (9) p(m,i)∈0, 1 is an indicator variable that is equal to 1 if and only if the customer order i is associated with manufacturing order m; (10) z(m)∈0, 1 is an indicator variable that is equal to 1 if and only if there exists a customer order associated with manufacturing order m; and (11) r(i) is an indicator variable, where r(i)=1 if and only if the i-th order is fulfilled.

Constraints are given as follows:

$$∀ m , i , j , k : w ( m , i , j , k ) = {w}^{( b )} ( m , i , j , k ) + {w}^{( t )} ( m , i , j , k )$$

$$∀ m , i , j ∉ {S}^{( t )} , k : {w}^{( t )} ( m , i , j , k ) = 0$$

The total weight used from each lot is less than the available quantity:

$$∀ j , k : {\sum }_{m , i} w ( m , i , j , k ) \leq W ( j , k )$$

The total weight for each order matches the requirement if the customer order is fulfilled:

$$∀ j : {\sum }_{m , j , k} w ( m , i , j , k ) = T ( i ) \cdot r ( i )$$

The deviation from quality lower bounds (for orders that are fulfilled):

$$∀ i , r : b ( i , r ) \geq {\sum }_{m} ( L ( i , r ) \cdot {\sum }_{i , j , k} w ( m , i , j , k ) - {\sum }_{i , j , k} ( Q ( j , k , r ) \cdot w ( m , i , j , k ) ) ) = L ( i , r ) \cdot {\sum }_{m , i , j , k} w ( m , i , j , k ) - {\sum }_{m , i , j , k} ( Q ( j , k , r ) \cdot w ( m , i , j , k ) ) b ( i , r ) \geq 0$$

The deviation from upper quality bounds:

$$∀ i , r : a ( i , r ) \geq {\sum }_{m} ( {\sum }_{i , j , k} ( Q ( j , k , r ) \cdot w ( m , i , j , k ) ) - U ( i , r ) \cdot {\sum }_{i , j , k} w ( m , i , j , k ) ) = {\sum }_{m , i , j , k} ( Q ( j , k , r ) \cdot w ( m , i , j , k ) ) - U ( i , r ) \cdot {\sum }_{m , i , j , k} w ( m , i , j , k ) a ( i , r ) \geq 0$$

A product layer is used only if all layers below it has already been used:

$$∀ m , j , k : {\sum }_{{m}^{′} \leq m , i , {k}^{′} \leq k - 1} {w}^{( b )} ( {m}^{′} , i , k , {k}^{′} ) \geq {\sum }_{{k}^{′} \leq k - 1} W ( j , {k}^{′} ) - M \cdot ( 1 - {y}^{( b )} ( m , j , k ) )$$

$$∀ m , i , j , k : {w}^{( b )} ( m , i , j , k ) \leq M \cdot {y}^{( b )} ( m , j , k )$$

$$∀ m , j , k : {y}^{( b )} ( m , j , k ) ∈ 0 , 1$$

For storage units that allow top-down access, a layer can be used only if all layers above it have been used up:

$$∀ m , j ∈ {S}^{( t )} , k : {\sum }_{{m}^{′} \leq m , i , {k}^{′} \geq k + 1} {w}^{( t )} ( {m}^{′} , i , k , {k}^{′} ) \geq {\sum }_{{k}^{′} ∖ g eq k + 1} W ( j , {k}^{′} ) - M \cdot ( 1 - {y}^{( t )} ( m , j , k ) )$$

$$∀ m , i , j , k : {w}^{( t )} ( m , i , j , k ) \leq M \cdot {y}^{( t )} ( m , j , k )$$

$$∀ m , j , k : {y}^{( t )} ( m , j , k ) ∈ 0 , 1$$

Use at most X storage units for each order:

$$∀ m , j : {\sum }_{j , k} w ( m , i , j , k ) \leq M \cdot x ( m , j )$$

$$∀ m : {\sum }_{j} x ( m , j ) \leq X$$

Next, mapping customer orders to manufacturing orders is described:

Assigning product to a customer order index i only if the customer order is assigned to the manufacturing order m:

$$∀ m , i : {\sum }_{j , k} w ( m , i , j , k ) \leq M \cdot p ( m , i )$$

$$∀ i : {\sum }_{m} p ( m , i ) \leq r ( i )$$

A manufacturing order m can satisfy up to I customer orders, only if it is active:

$$∀ m : {\sum }_{i} p ( m , i ) \leq I \cdot z ( m )$$

If a manufacturing order m is active, then it fulfills at least one customer order:

$$∀ m : {\sum }_{i} p ( m , i ) \geq z ( m )$$

The total number of customer orders mapped is equal to the total active customer orders:

$${\sum }_{m , i} p ( m , i ) = {\sum }_{i} z ( i )$$

The active manufacturing orders start from m=0 and use indices continuously:

$$∀ m : z ( m ) \leq z ( m + 1 )$$

The multiple parts of this objective constitute a minimization problem in terms of the following:

(1) Minimize the number of orders that are not fulfilled (with a high priority/weight):

$$I - {\sum }_{i} r ( i )$$

(2) Minimize the number of manufacturing orders:

$${\sum }_{m} z ( m )$$

(3) Minimize total cost:

$${\sum }_{m , i , j , k} C ( j , k ) \cdot w ( m , i , j , k )$$

(4) Minimize the deviation from the lower bounds for the quality parameter:

$${\sum }_{i , r} b ( i , r )$$

(5) Minimize the deviation from the upper bounds for the quality parameter:

$${\sum }_{i , r} a ( i , r )$$

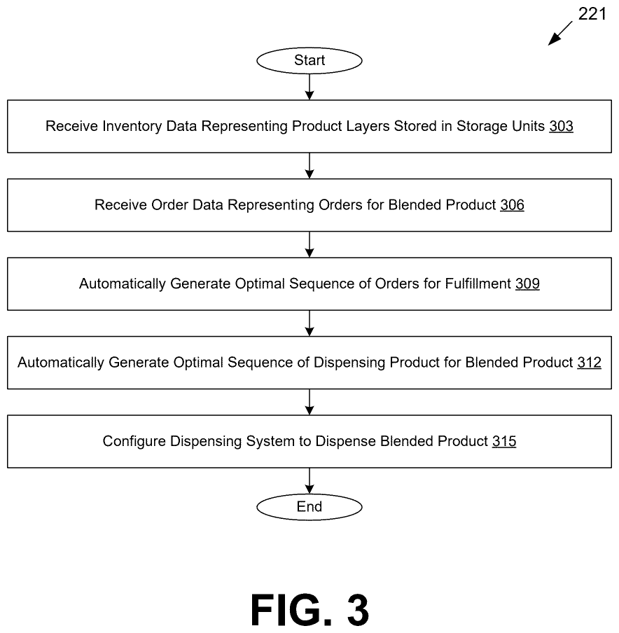

Referring next to FIG. 3, shown is a flowchart that provides one example of the operation of a portion of the blending optimization service 221 according to various embodiments. It is understood that the flowchart of FIG. 3 provides merely an example of the many different types of functional arrangements that may be employed to implement the operation of the portion of the blending optimization service 221 as described herein. As an alternative, the flowchart of FIG. 3 may be viewed as depicting an example of elements of a method implemented in the computing environment 203 (FIG. 2) according to one or more embodiments.

Beginning with box 303, the blending optimization service 221 receives inventory data 233 representing product layers stored in storage units. For example, the product layers may correspond to different lots of a grain, and the storage units may correspond to silos that are loaded to a top end and unloaded from a bottom end. The inventory data 233 that is received may include storage unit data 257, product layer data 260, and interface data 263.

In box 306, the blending optimization service 221 receives order data 236 representing a plurality of orders from customers for a blended product. The order data 236 may include, for each order, a quantity 275 of the blended product ordered, a set of target characteristics 277 that the blended product is to have, and a target date 279 by which the blended product is needed. The order data 236 may be received as part of various customers interacting using customer systems 215 to place orders via the network 219.

In box 309, the blending optimization service 221 automatically generates an optimal order fulfillment sequence 239 to assign an ordering or sequence to the plurality of orders, where the sequence is selected in order to minimize the number of orders that cannot be fulfilled given the target characteristics 277, the target date 279, cost, configuration parameters 248 and optimization objectives 251. The sequence may also be selected based at least in part on reduction of cost, ranges of acceptability for target characteristics 277 (such as meeting or exceeding the target characteristics 277), a number of storage units that can be used to dispense a single blended product, and other goals and constraints.

In box 312, the blending optimization service 221 may automatically generate an optimal product dispensing sequence 242, where the sequence is used to dispense blended products in an optimal way to fulfill an order, which may be the next order in the optimal order fulfillment sequence 239. For example, the sequence may indicate that 30 Liters of grain X are dispensed from silo A and 50 Liters of grain Y are dispensed from silo B, which may be mixed together to produce 80 Liters of a mixture of grain X and grain Y. The resulting set of characteristics may be determined through the proportion of three-eighths times the respective characteristics 269 of grain X plus five-eighths times the respective characteristics 269 of grain Y.

An interface between the product layer used and the adjacent product layer may be taken into account in some embodiments. The interface may have a quantity 271 and a set of characteristics 273, which is based on the blend between the product layer and the adjacent product layer. The characteristics 273 and quantity 271 may be utilized to determine the resulting characteristics of the blended product, for comparison to the target characteristics 277 specified in the order. The interface need not be taken into account if some amount less than the full quantity of the product layer is utilized, such that portions of the adjacent layer are not dispensed along with the desired product layer.

The optimal product dispensing sequence 242 may be determined based at least in part on a maximum number of storage units to be drawn from in fulfilling the respective order. For example, a configuration parameter 248 may control that no more than four silos may be used to blend grain for an order.

The optimal order fulfillment sequence 239 and/or the optimal product dispensing sequence 242 may be determined through the use of a mixed-integer linear programming model and/or a machine learning model 227. In some embodiments, the machine learning model 227 is trained based upon manually curated training data corresponding to past orders fulfilled through the system. The machine learning model 227 may discern an optimal sequence for fulfilling orders or dispensing product.

In box 315, the blending optimization service 221 configures one or more dispensing systems 209 to dispense the product according to the optimal product dispensing sequence 242 and/or the optimal order fulfillment sequence 239. For example, the blending optimization service 221 may cause one or more valves 109 (FIG. 1A) to be actuated to dispense quantities of product into a mixing/dispensing system such as the outflow system 107. The blended product can then be loaded onto vehicles, rail cars, pipelines, conveyors, and/or other systems for transport to customers or to a next step in a manufacturing process.

In another embodiment, a user interface may report information relating to the optimal product dispensing sequence 242 and/or the optimal order fulfillment sequence 239 generated by the blending optimization service 221, so that users may manually operate valves 109 and/or other dispensing systems 209 to dispense the correct quantities at the appropriate times. Thereafter, the operation of the portion of the blending optimization service 221 ends.

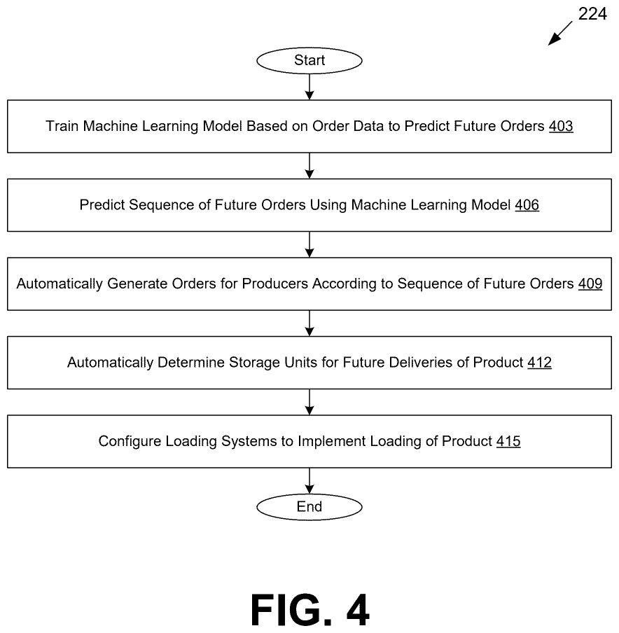

Moving on to FIG. 4, shown is a flowchart that provides one example of the operation of a portion of the intake optimization service 224 according to various embodiments. It is understood that the flowchart of FIG. 4 provides merely an example of the many different types of functional arrangements that may be employed to implement the operation of the portion of the intake optimization service 224 as described herein. As an alternative, the flowchart of FIG. 4 may be viewed as depicting an example of elements of a method implemented in the computing environment 203 (FIG. 2) according to one or more embodiments.

Beginning with box 403, the intake optimization service 224 trains a machine learning model 227 based at least in part on order data 236 to predict future orders from customers. For example, the machine learning model 227 may be trained to recognize certain patterns in orders such that periodicity in order placement for particular product blends can be identified and predicted. In box 406, the intake optimization service 224 predicts a sequence of future orders based at least in part on the machine learning model 227.

In box 409, the intake optimization service 224 may automatically generate orders for producers based at least in part on the sequence of predicted future orders. In automatically generating the orders, the intake optimization service 224 may communicate with one or more producer systems 218 in order to place the orders with the respective producers. In this way, the inventory that is necessary to fulfill the future orders will be ordered from the producers in a timely manner and be prepared for loading in the storage units.

In box 412, the intake optimization service 224 automatically determines particular storage units for future deliveries of product lots. In box 415, the intake optimization service 224 may configure one or more loading systems 212 to implement the loading of the product to the determined storage unit. The intake optimization service 224 may determine a sequence to load the product to the storage units, in a way that the usage of the product from the storage units is optimal, where optimality minimizes the chance that orders cannot be fulfilled. In some examples, the producers may be queued for offloading their deliveries according to this sequence, or they may be directed to specific queues for each storage unit. Thereafter, the operation of the portion of the intake optimization service 224 ends.

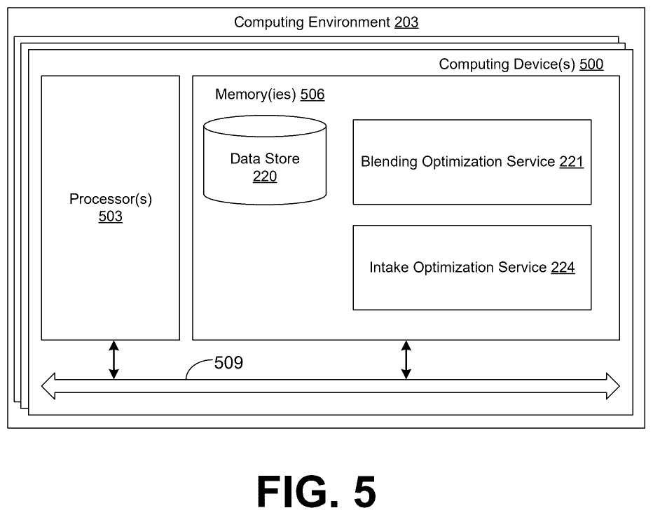

With reference to FIG. 5, shown is a schematic block diagram of the computing environment 203 according to an embodiment of the present disclosure. The computing environment 203 includes one or more computing devices 500. Each computing device 500 includes at least one processor circuit, for example, having a processor 503 and a memory 506, both of which are coupled to a local interface 509. To this end, each computing device 500 may comprise, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are the blending optimization service 221, the intake optimization service 224, and potentially other applications. Also stored in the memory 506 may be a data store 220 and other data. In addition, an operating system may be stored in the memory 506 and executable by the processor 503.

It is understood that there may be other applications that are stored in the memory 506 and are executable by the processor 503 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, universal serial bus (USB) flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the blending optimization service 221, the intake optimization service 224, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3 and 4 show the functionality and operation of an implementation of portions of the blending optimization service 221 and the intake optimization service 224. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 3 and 4 show a specific order of execution, it is understood that the order of execution may differ from that which is depicted. For example, the order of execution of two or more blocks may be scrambled relative to the order shown. Also, two or more blocks shown in succession in FIGS. 3 and 4 may be executed concurrently or with partial concurrence. Further, in some embodiments, one or more of the blocks shown in FIGS. 3 and 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the blending optimization service 221 and the intake optimization service 224, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the blending optimization service 221 and the intake optimization service 224, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or in multiple computing devices 500 in the same computing environment 203.

Unless otherwise explicitly stated, articles such as “a” or “an”, and the term “set”, should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, wherein when executed the program causes the at least one computing device to at least:
receive inventory data representing a plurality of grain layers stored in a plurality of silos, the inventory data indicating a quantity for each of the plurality of grain layers and a set of characteristics for each of the plurality of grain layers;
receive order data representing a plurality of orders for a grain blend, each of the plurality of orders specifying a respective set of target characteristics for the grain blend and a respective quantity; and
automatically generate, based at least in part on the inventory data and the order data, an optimal sequence of the plurality of orders for fulfillment and an optimal sequence for dispensing grain from the plurality of silos for the grain blend of each respective order of the plurality of orders.

2. The non-transitory computer-readable medium of claim 1, wherein the set of characteristics comprises at least one of: moisture, extract fine, extract coarse, color, protein, Kolbach index, free amino nitrogen, or beta-glucan.

3. The non-transitory computer-readable medium of claim 1, wherein a respective grain layer in one of the plurality of silos is accessible only after all grain layers under the respective grain layer have been dispensed.

4. The non-transitory computer-readable medium of claim 1, wherein the optimal sequence of the plurality of orders for fulfillment and the optimal sequence for dispensing grain from the plurality of storage units for the grain blend of each respective order of the plurality of orders are optimal in terms of minimizing a number of the plurality of orders that cannot be fulfilled with the respective set of target characteristics.

5. A computer-implemented method, comprising:
receiving inventory data representing a plurality of product layers stored in a plurality of storage units, the inventory data indicating a product quantity for each of the plurality of product layers and a set of characteristics for each of the plurality of product layers;
receiving order data representing a plurality of orders for a blended product, each of the plurality of orders specifying a respective set of target characteristics for the blended product and a respective quantity; and
automatically generating, based at least in part on the inventory data and the order data, at least one of: an optimal sequence of the plurality of orders for fulfillment, or an optimal sequence for dispensing product from the plurality of storage units for the blended product of each respective order of the plurality of orders.

6. The computer-implemented method of claim 5, further comprising:
training a machine learning model based at least in part on the order data to predict future orders;
predicting a sequence of future orders using the machine learning model; and
automatically determining one or more storage units of the plurality of storage units for future deliveries of product in order to fill the plurality of storage units in order to optimally fulfill the sequence of future orders.

7. The computer-implemented method of claim 5, wherein the optimal sequence of the plurality of orders for fulfillment and the optimal sequence for dispensing product from the plurality of storage units for the blended product of each respective order are generated based at least in part on ensuring that the blended product has a blended set of characteristics that meets or exceeds the respective set of target characteristics for the respective order.

8. The computer-implemented method of claim 5, wherein the optimal sequence of the plurality of orders for fulfillment and the optimal sequence for dispensing product from the plurality of storage units for the blended product of each respective order are generated based at least in part on a maximum number of storage units to be drawn from in fulfilling the respective order.

9. The computer-implemented method of claim 5, further comprising:
determining characteristics of an interface between an upper layer of the plurality of product layers and a lower layer of the plurality of product layers in a particular storage unit of the plurality of storage units; and
determining characteristics of the blended product based at least in part on the characteristics of the interface.

10. The computer-implemented method of claim 5, wherein the plurality of storage units are silos that are loaded from a top end and dispensed from a bottom end.

11. The computer-implemented method of claim 5, wherein the plurality of storage units are silos that are loaded and dispensed from a single end.

12. The computer-implemented method of claim 5, wherein the plurality of storage units are pipelines that are loaded from a first end and dispensed from a second end.

13. The computer-implemented method of claim 5, further comprising actuating one or more respective valves to dispense product from at least two of the storage units to fulfill a particular order of the plurality of orders.

14. A system, comprising:
a data store storing inventory data representing a plurality of product layers stored in a plurality of storage units, the inventory data indicating a product quantity for each of the plurality of product layers and a set of characteristics for each of the plurality of product layers;
the data store further storing order data representing a plurality of customer orders for a blended product, each of the plurality of customer orders specifying a respective set of target characteristics for the blended product and a respective quantity;
at least one computing device; and
instructions executable in the at least one computing device, wherein when executed the instructions cause the at least one computing device to at least:
automatically generate, based at least in part on the inventory data and the order data, at least one of: an optimal sequence of the plurality of customer orders for fulfillment, or an optimal sequence for dispensing product from the plurality of storage units for the blended product of each respective order of the plurality of customer orders.

15. The system of claim 14, wherein the instructions further cause the at least one computing device to at least:
train a machine learning model based at least in part on the order data to predict future orders;
predict a sequence of future orders using the machine learning model; and
automatically determine one or more storage units of the plurality of storage units for future deliveries of product in order to fill the plurality of storage units in order to optimally fulfill the sequence of future orders.

16. The system of claim 14, wherein the optimal sequence of the plurality of customer orders for fulfillment and the optimal sequence for dispensing product from the plurality of storage units for the blended product of each respective order are generated based at least in part on ensuring that the blended product has a blended set of characteristics that meets or exceeds the respective set of target characteristics for the respective order.

17. The system of claim 14, wherein the optimal sequence of the plurality of customer orders for fulfillment and the optimal sequence for dispensing product from the plurality of storage units for the blended product of each respective order are generated based at least in part on a maximum number of storage units to be drawn from in fulfilling the respective order.

18. The system of claim 14, wherein the instructions further cause the at least one computing device to at least:
determine characteristics of an interface between an upper layer of the plurality of product layers and a lower layer of the plurality of product layers in a particular storage unit of the plurality of storage units; and
determine characteristics of the blended product based at least in part on the characteristics of the interface.

19. The system of claim 14, wherein the plurality of storage units are silos that are loaded from a top end and dispensed from a bottom end, the plurality of storage units are pipelines that are loaded from a first end and dispensed from a second end, or the plurality of storage units are loaded and dispensed from a single end.

20. The system of claim 14, further comprising:
one or more electrically actuated valves coupled to each respective storage unit to dispense product from the respective storage unit; and
wherein the instructions further cause the at least one computing device to at least actuate the one or more electrically actuated valves to dispense product from at least two of the storage units to fulfill a particular order of the plurality of customer orders.
